(19) United States
(12) Patent Application Publication
(10) Pub. No.: US 2013/0181449 A1
(43) Pub. Date: Jul. 18, 2013

(54) System and Method for Controlling a Variable Speed Ratio Friction Wheel Drive Train on a Wind Turbine

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/349,232

(22) Filed: Jan. 12, 2012

(51) Int. Cl. H02P 9/06

(52) U.S. Cl. 290/44

(57) ABSTRACT

A system and method for controlling operation of a friction wheel drive train for a wind turbine is disclosed. The control system may include a system controller capable of regulating an output rotational speed of one or more generators driven by the drive train, at least one electrical sensor in at least indirect communication with the system controller for providing measurements thereto, at least one electrical contactor for establishing a connection between the one or more generators and a grid and an actuation system in at least indirect contact with the system controller and operating under command thereof to regulate the output rotational speed of the one or more generators.

### FIELD OF THE DISCLOSURE

The present disclosure relates generally to wind turbines and, more particularly, relates to variable speed ratio friction wheel drive trains and control thereof on wind turbines.

### BACKGROUND OF THE DISCLOSURE

A utility-scale wind turbine typically includes a set of two or three large rotor blades mounted to a rotor hub. The rotor blades and the rotor hub together are referred to as the rotor. The rotor blades aerodynamically interact with the wind and create lift and drag, which is then translated into a driving torque by the rotor hub. The rotor is attached to and drives a main shaft, which in turn is operatively connected via a drive train to a generator or a set of generators that produce electric power. The main shaft, the drive train and the generator(s) are all situated within a nacelle, which is situated on top of a tower.

Many types of drive trains are known for connecting the main shaft to the generator(s). One type of drive train uses various designs and types of speed increasing gearboxes to connect the main shaft to the generator(s). Typically, the gearboxes include one or more stages of gears and a large housing, wherein the stages increase the rotor speed to a speed that is more desirable for driving the generator(s). While effective, large forces translated through the gearbox can deflect the gearbox housing and components therein and displace the large gears an appreciable amount so that the alignment of meshing gear teeth can suffer. When operating with misaligned gear teeth, the meshing teeth can be damaged, resulting in a reduced lifespan. The large size of these gearboxes and the extreme loads handled by them (including transient over torque conditions) make them even more susceptible to deflections and resultant premature wear and damage, such as gear pitting. Furthermore, maintenance and/or replacement of parts of damaged gearboxes may not only be difficult and expensive, it may require entire gearboxes to be lifted down from the wind turbine.

To counteract the disadvantages of traditional gearboxes, some wind turbines have started employing friction wheel drive trains. Friction wheel drive trains replace conventional gearboxes in a wind turbine and include at least one drive wheel and at least one driven wheel as speed increasing stages that drive (e.g., control the output speed of) the generator(s) connected thereto. Motion in friction wheel drive trains is transmitted from the drive wheel(s) to the driven wheel(s) through frictional forces. Most friction wheel drive trains that are currently employed are constant speed ratio speed increaser drive trains in which the output rotational speed of the generator(s) varies as the rotational speed of the wind turbine varies.

Such constant speed ratio friction wheel drive trains are not only inefficient, they are also expensive to own, install and maintain, and are mostly employed in low power rating wind turbines. Furthermore, since the output rotational speed of the generator(s) connected to the driven wheel(s) of the constant speed ratio friction wheel drive train varies as the wind turbine rotational speed varies, the output frequency of the generator(s) varies as well. In order to transmit the generator power to an electric grid, a fixed frequency alternating current (AC) wave form must be produced by the generator(s) and synchronized to the grid. With wind turbines employing constant speed ratio friction wheel drive trains and variable frequency generator(s), a fixed output frequency of the generator(s) is typically accomplished by first rectifying the alternating current generator output power (from AC) to direct current (DC) power. This DC power is then inverted to create a fixed frequency AC wave form. The power electronic equipment utilized to rectify and invert the wind turbine generator output power is not only expensive, it is also inefficient and unreliable.

Given these disadvantages of constant speed ratio friction wheel drive trains, variable speed ratio speed increaser friction wheel drive trains were created in which the output rotational speed of the generators is regulated to a fixed speed, independent of the input rotational speed of the wind turbine. Regulation of the output rotational speed of the generator(s) may be achieved by controlling the operation of the variable speed ratio friction wheel drive train. Accurate control of the generator output rotational speed is needed to control generator power flow to the electric grid. For example, once the AC output frequency of each generator is synchronized to the grid, the generator power leads are connected to the electric grid. After synchronization and connection to the electric grid, if the wind turbine tries to increase the output rotational speed of the generator(s), the output rotational speed needs to remain constant such that electrical current may flow from the generator(s) to the electric grid. On the other hand, if the wind turbine tries to decrease the output rotational speed of the synchronized and connected generator(s), the output rotational speed of the generator(s) again needs to be regulated (e.g., maintained at a constant speed) to prevent electric current from flowing from the electric grid to the generator(s), causing the generator(s) to act as motors trying to maintain their synchronous speed.

Accordingly, a system and method is needed to accurately control a variable speed ratio frication wheel drive train in order to accurately regulate the output rotational speed of the generator(s) to not only synchronize the generator(s) to the electric grid, but also to control current flow between the generator(s) and the electric grid.

### SUMMARY OF THE DISCLOSURE

In accordance with one aspect of the present disclosure, a control system for controlling operation of a drive train for a wind turbine is disclosed. The control system may include a system controller capable of regulating an output rotational speed of one or more generators driven by a drive train of a wind turbine and at least one electrical sensor for measuring at least an output frequency of the one or more generators, a frequency of a grid and a rate of current flow between the one or more generators and the grid, the at least one electrical sensor in at least indirect communication with the system controller for providing measurements thereto. The control system may also include at least one electrical contactor for establishing a connection between the one or more generators and the grid, the at least one electrical contactor in at least indirect communication with the system controller and operating under command from the system controller and an actuation system in at least indirect contact with the system controller and operating under command thereof to regulate the output rotational speed of the one or more generators.

In accordance with another aspect of the present disclosure, a wind turbine is disclosed. The wind turbine may include a hub, a plurality of blades radially extending from the hub, a main shaft rotating with the hub and a friction wheel drive train comprising (a) at least one drive wheel mounted to the main shaft and rotating at a variable input rotational speed; and (b) at least one driven wheel in at least indirect contact with the at least one drive wheel, the at least one driven wheel capable of providing a constant output rotational speed of one or more generators connected to the at least one driven wheel by varying a speed ratio of the friction wheel drive train. The wind turbine may also include a control system capable of controlling the output rotational speed of the one or more generators to at least (a) synchronize an output frequency of the one or more generators with a frequency of a grid; and (b) after synchronizing, controlling current flow from the one or more generators to the grid.

In accordance with yet another aspect of the present disclosure, a method of controlling operation of a friction wheel drive train for a wind turbine is disclosed. The method may include providing a control system having (a) a system controller capable of regulating an output rotational speed of one or more generators driven by a drive train of a wind turbine; (b) at least one electrical sensor for measuring at least an output frequency of the one or more generators, a frequency of a grid and a rate of current flow between the one or more generators and the grid, the at least one electrical sensor in at least indirect communication with the system controller for providing measurements thereto; (c) at least one electrical contactor for establishing a connection between the one or more generators and the grid, the at least one electrical contactor in at least indirect communication with the system controller and operating under command from the system controller; and (d) an actuation system in at least indirect contact with the system controller and operating under command thereof to regulate the output rotational speed of the one or more generators and receiving measurements by the system controller from the at least one electrical sensor. The method may also include synchronizing the output frequency of the one or more generators with the frequency of the grid by utilizing the actuation system based upon the measurements received from the at least one electrical sensor, connecting the one or more generators to the grid after synchronizing by closing the at least one electrical contactor and controlling electric current flowing from the one or more generators to the grid after synchronizing and connecting the one or more generators to the grid by utilizing the actuation system based upon the measurements received from the at least one electrical sensor.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary block diagram of a control system for controlling a variable speed friction wheel drive train for use within the wind turbine of FIG. 1;

FIGS. 3 and 4 show operation of the control system in accordance with a first embodiment of the present disclosure;

FIGS. 5 and 6 show operation of the control system in accordance with a second embodiment of the present disclosure;

FIGS. 7 and 8 show operation of the control system in accordance with a third embodiment of the present disclosure; and

FIGS. 9 and 10 show operation of the control system in accordance with a fourth embodiment of the present disclosure.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

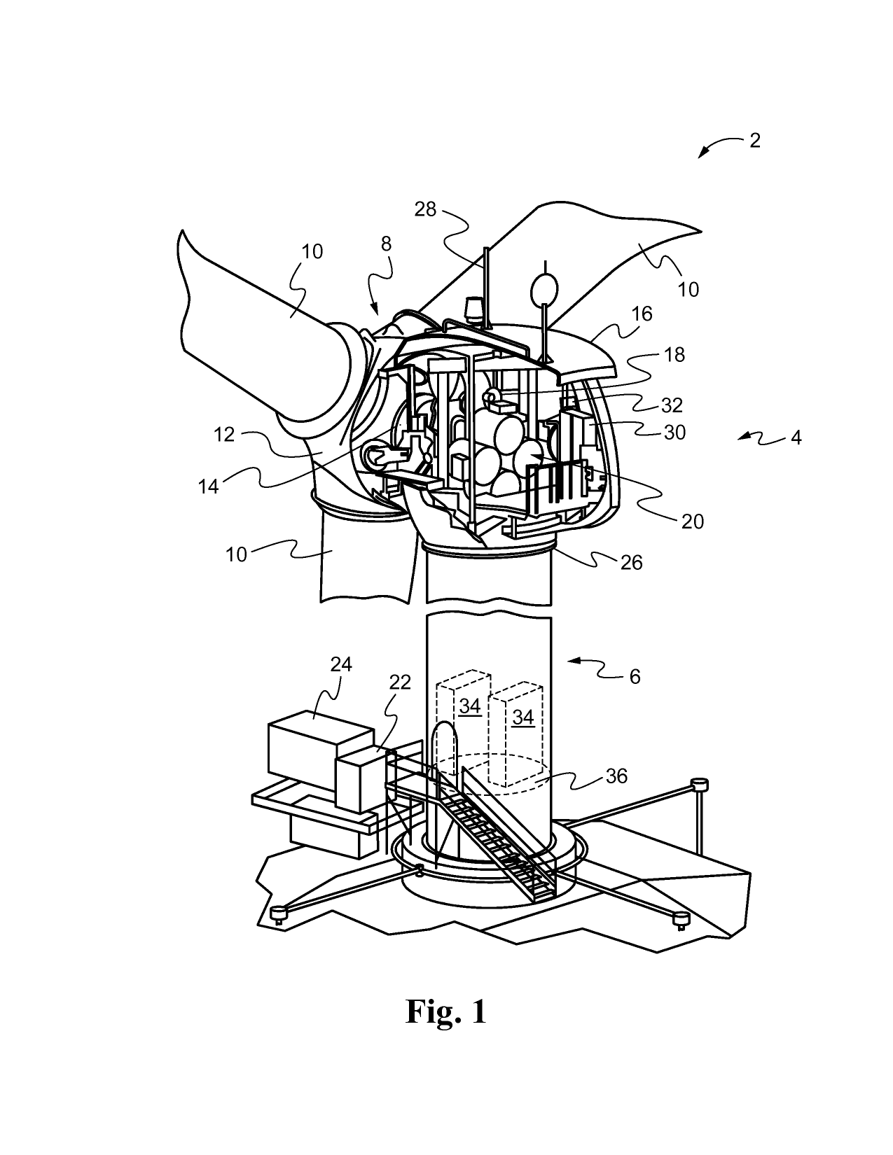

Referring now to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8, which in turn may include a plurality of blades 10 connected to a hub 12. The blades 10 may rotate with wind energy and the rotor 8 may transfer that energy to a main shaft 14 situated within a nacelle 16. The nacelle 16 may additionally include a drive train 18 (e.g., a friction wheel drive train), which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to a grid (not shown). The PDP 22 and the PMT 24 may also provide electrical power from the grid to the wind turbine for powering several components thereof.

In addition to the components of the wind turbine 2 described above, the up tower section 4 of the wind turbine may include several auxiliary components, such as, a yaw system 26 on which the nacelle 16 may be positioned to pivot and orient the wind turbine in a direction of the prevailing wind current or another preferred wind direction, a pitch control unit (PCU) (not visible) situated within the hub 12 for controlling the pitch (e.g., angle of the blades with respect to the wind direction) of the blades 10, a hydraulic power system (not visible) to provide hydraulic power to various components such as brakes of the wind turbine, a cooling system (also not visible), a lightning rod 28 for protecting the wind turbine from lightning strikes, and the like. Notwithstanding the auxiliary components of the wind turbine 2 described above, it will be understood that the wind turbine 2 may include several other auxiliary components that are contemplated and considered within the scope of the present disclosure. Furthermore, a turbine control unit (TCU) 30 and a control system 32 (one or both of which may be classified as auxiliary components) may be situated within the nacelle 16 for controlling the various components of the wind turbine 2.

With respect to the down tower section 6 of the wind turbine 2, among other components, the down tower section may include a pair of generator control units (GCUs) 34 and a down tower junction box (DJB) 36 for routing and distributing power between the wind turbine and the grid. Several other components, such as, ladders, access doors, etc., that may be present within the down tower section 6 of the wind turbine 2 are contemplated and considered within the scope of the present disclosure.

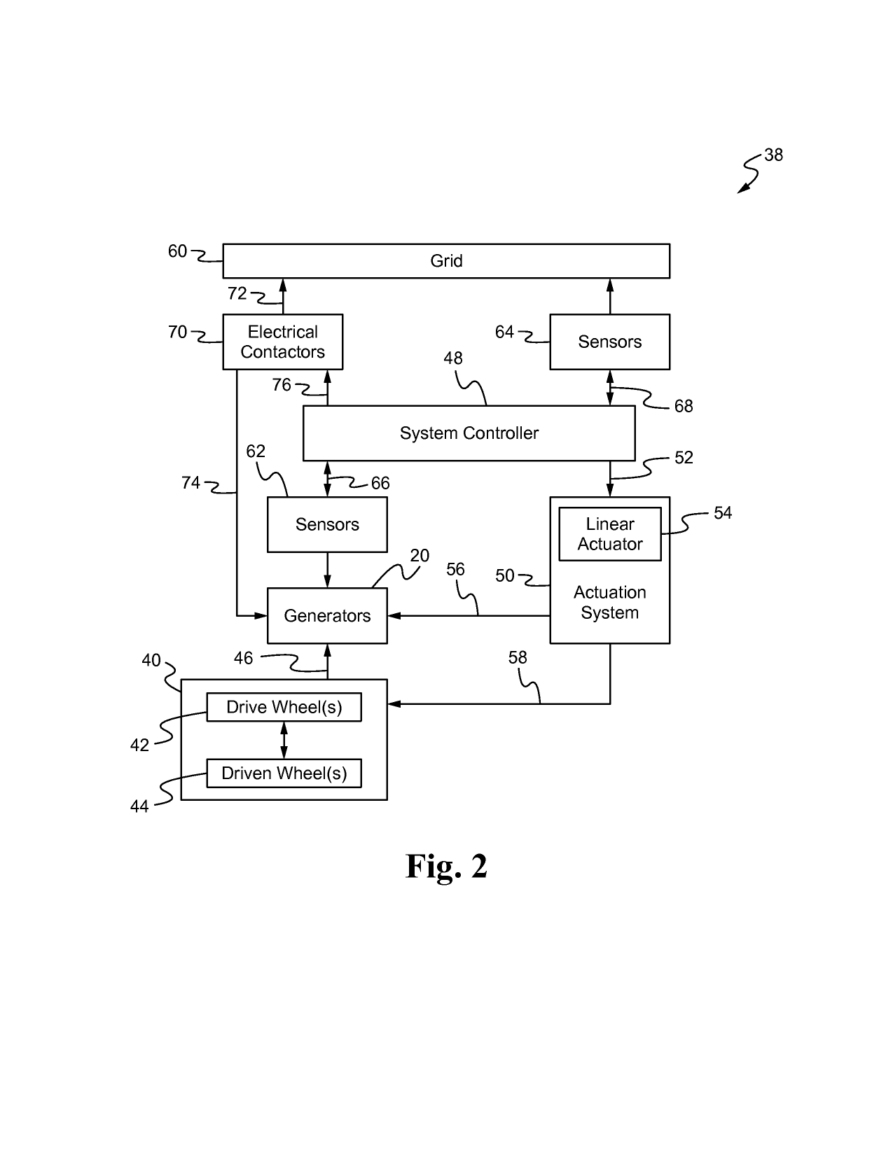

Referring now to FIG. 2, an exemplary block diagram of a control system 38 is shown, in accordance with at least some embodiments of the present disclosure. As will be described further below, the control system 38 may be employed to control an output speed of the one or more generators 20 connected to the drive train 18, as the input speed (or the rotating speed) of the wind turbine 2 varies. The drive train 18 may be a friction wheel speed increaser drive train and particularly, a variable speed ratio friction wheel drive train 40 having at least one drive wheel (also referred to herein as a driving wheel) 42 mounted onto the main shaft 14 and driving at least one driven wheel 44. The generators 20 may be connected to the driven wheel(s) 44 of the friction wheel drive train 40, the connection being represented by link 46. In operation, when the drive wheel(s) 42 are rotated by the wind turbine 2 (e.g., by the rotor 8), and the driven wheel(s) 44 are forced (e.g., rotated and/or translated) against the drive wheel(s), rotational motion from the drive wheel(s) is transferred via frictional forces to the driven wheel(s) and a constant output rotational speed of the generators 20 may be maintained independent of the speed of the wind turbine by utilizing the control system 38.

Furthermore, by rotating and/or translating the driven wheel(s) 44 relative to the drive wheel(s) 42, an increase or decrease in the desired speed ratio may be achieved, thereby providing a variable speed ratio speed increaser. Specifically, the driven wheel(s) 44 may be translated relative to the drive wheel(s) 42 in a radial or an axial upwind or downwind direction or a combination thereof to achieve the speed ratio increase or decrease. By virtue of translating the driven wheel(s) 44 relative to the drive wheel(s), an effective circumference or location of contact between the drive and the driven wheels may be gradually decreased or increased, which in turn may decrease or increase the speed ratio of the friction wheel drive train 40. For example, for a desired speed ratio of, for example, 10:1, if the rotational speed of the wind turbine 2 drops below a nominal speed, the speed of the generators 20 may begin to drop as well. If this occurs, then the speed ratio may be increased by translating the driven wheel(s) 44 relative to the drive wheel(s) 42 until the desired generator speed is achieved. Relatedly, if the rotational speed of the wind turbine 2 increases, the speed of the generators 20 may also begin to increase. If this occurs, then the speed ratio may be decreased by again translating the driven wheel(s) 44 relative to the drive wheel(s) 42 until the desired generator speed is once again obtained.

Translation of the driven wheel(s) 44 relative to the drive wheel(s) 42 to increase or decrease the speed ratio to maintain a constant output speed of the generators 20 may be facilitated by a system controller 48, described in greater detail below. The translation of the drive and the driven wheels 42 and 44, respectively, to increase or decrease the speed ratio may be achieved by an actuation system 50, which may be operated under control of the system controller 48, as indicated by link 52. In at least some embodiments, the actuation system 48 may include a linear actuator 54 that may be in at least indirect contact with the generators 20 and/or the variable speed ratio friction wheel drive train 40, as shown by links 56 and 58, respectively, to vary the speed ratio in order to regulate the output rotational speed of the generators. In at least some of those embodiments employing the linear actuator 54, the linear actuator may be extended or retracted towards or away, respectively, from the generators 20 and/or the driven wheel(s) 44 of the friction wheel drive train 40 to translate the driven wheel(s) relative to the drive wheel(s) 42 to vary the speed ratio, as will be explained further below. One of the linear actuator 54 may be employed for each pair of the drive wheel(s) 44 and the generators 20 in some embodiments to increase or decrease the speed ratio of each pair as desired.

Notwithstanding the fact that in the present embodiment, the linear actuator 54 has been employed for varying the speed ratio of the friction wheel drive train 40 under control of the system controller 48, in at least some embodiments, translation of the driven wheel(s) 44 relative to the drive wheel(s) 42 may be achieved by any of variety of mechanical or electromechanical devices, such as, a hydraulic ramp, a rack and pinion, a ball screw, a slider crank, or any other actuator capable of facilitating a linear motion (in case of flat disks) and/or traversing a convex or concave path, via a curved path of motion (in case of concave or convex disks).

Referring still to FIG. 2, accurate control of the output rotational speed of the generators 20 is needed to control power flow from the generators to a grid 60, as discussed above. Specifically, for flowing power from the generators 20 to the grid 60, an AC output frequency of the generators needs to be synchronized with an AC frequency of the grid 60. Since the output frequency of the generators 20 varies with the input rotational speed of the generators, accurate control of the input rotational speed of the generators is needed to synchronize the generators to the grid 60. Such accurate control may be achieved by increasing or decreasing the speed ratio of the variable speed ratio friction wheel drive train 40 depending upon whether the AC output frequency of the generators 20 leads or lags the frequency of the grid 60. As will be discussed further below, the speed ratio may be increased or decreased (to regulate the output rotational speed of the generators 20) by way of the system controller 48.

Once the output frequency of each of the generators 20 is synchronized to the grid 60, the generator power leads may be connected to the grid for supplying power to the grid. Furthermore, after the output frequency of the generators 20 is synchronized to the grid 60, accurate control of the output rotational speed of the generators 20 is again needed to regulate current flow from the generators to the grid 60. For example, if the wind turbine 2 tries to increase the speed of the synchronized and connected generators, the generator output rotational speed needs to be regulated (e.g., remain constant) such that electrical current (or power) may flow from the generators to the grid 60. On the other hand, if the wind turbine 2 tries to decrease the rotational speed of the synchronized and connected generators 20, the output rotational speed of the generators again needs to be regulated (e.g., remain constant) to prevent current from flowing from the grid 60 to the generators, causing the generators to act as motors trying to maintain their synchronous speed. As above, this accurate regulation of the output rotational speed of the generators 20 may be achieved by increasing or decreasing the speed ratio of the variable speed ratio friction wheel drive train 40 under command from the system controller 48.

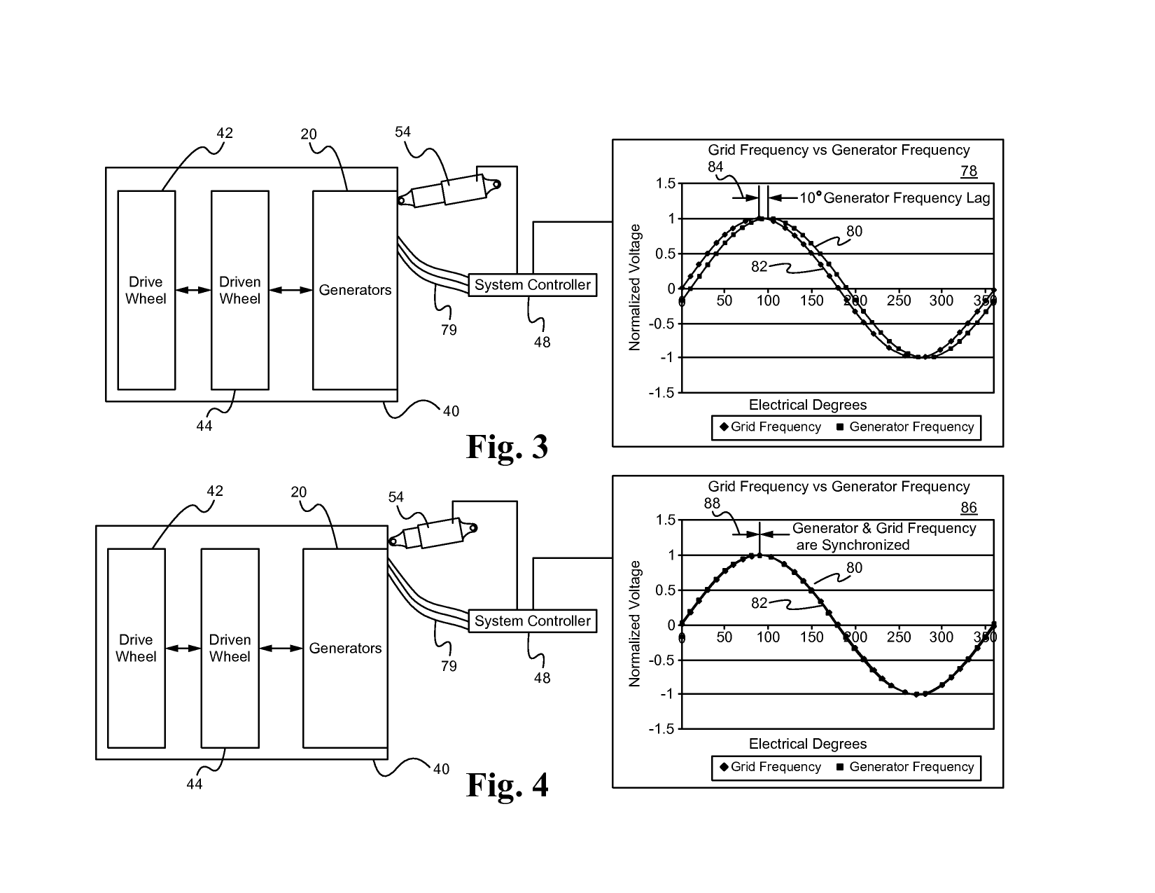

Furthermore, the determination of whether the output frequency of the generators 20 is synchronized to the grid 60 or not and when synchronized, whether current is flowing from the generators to the grid or from the grid to the generators is also made by the system controller 48. To make this determination, the system controller 48 may employ one or more electrical sensors 62 for measuring an output frequency of the generators 20 and a rate of electrical current flowing from the generators to the grid 60, as well as electrical sensors 64 for measuring the frequency of the grid and the rate of current flowing thereto. Information may be provided from the sensors 62 and 64 to the system controller 48 via links 66 and 68, respectively, and the system controller may utilize that information to control the linear actuator 54 to vary the speed ratio of the variable speed ratio friction wheel drive train 40 for maintaining a constant output speed of the generators 20 in order to synchronize the output frequency of the generators to the grid, as well as for ensuring that power flows from the generators to the grid (and not from the grid to the generators) after synchronization. The various modes of operation of the system controller 48 are described in greater detail in FIGS. 3-10 below.

The control system 38 may also employ one or more electrical contactors 70 that may be utilized for connecting the generators 20 to the grid 60 after the generators have been synchronized to the grid. In at least some embodiments, the electrical contactors 70 may be simple switches that may remain open until the generators 20 have been synchronized to the grid 60 and after synchronization, may be closed to establish connection between the generators and the grid to facilitate power flow from the generators to the grid, as shown by links 72 and 74. The electrical contactors 70 may be operated under command by the system controller 48, as represented by link 76. In other embodiments, the electrical contactors 70 may be devices other than electrical switches.

Furthermore, the system controller 48 may be a stand-alone embedded or general purpose processing system having any of a variety of volatile or non-volatile memory/storage devices, such as, flash memory, read only memory (ROM), programmable read only memory (PROM), erasable programmable read only memory (EPROM), electronically erasable programmable read only memory (EEPROM), etc., processing devices and computer readable media, such as, joy sticks, flash drives, optical disc drives, floppy discs, magnetic tapes, drums, cards, etc. Other types of computing, processing as well as reporting and storage devices may be present within (or used in conjunction with) the system controller 48. Furthermore, the system controller 48 may be located within the wind turbine 2 (e.g., within the nacelle 16 or the down tower section 6), or alternatively, it may be located remotely at a remote monitoring and diagnostics center (RMDC) and capable of communicating with the wind turbine 2. In at least some embodiments, the system controller 48 may possibly be a part of the TCU 30 and/or the control system 32 as well. In addition, the links 46, 52, 56, 58, 66, 68, 72, 74 and 76 are intended to be representative of a variety of analog or digital communication/data transfer media that are commonly employed in wind turbine settings including, but not limited to, wired or wireless links, buses, radio channels, or links involving the internet or the World Wide Web. Other types of communication links may also be employed.

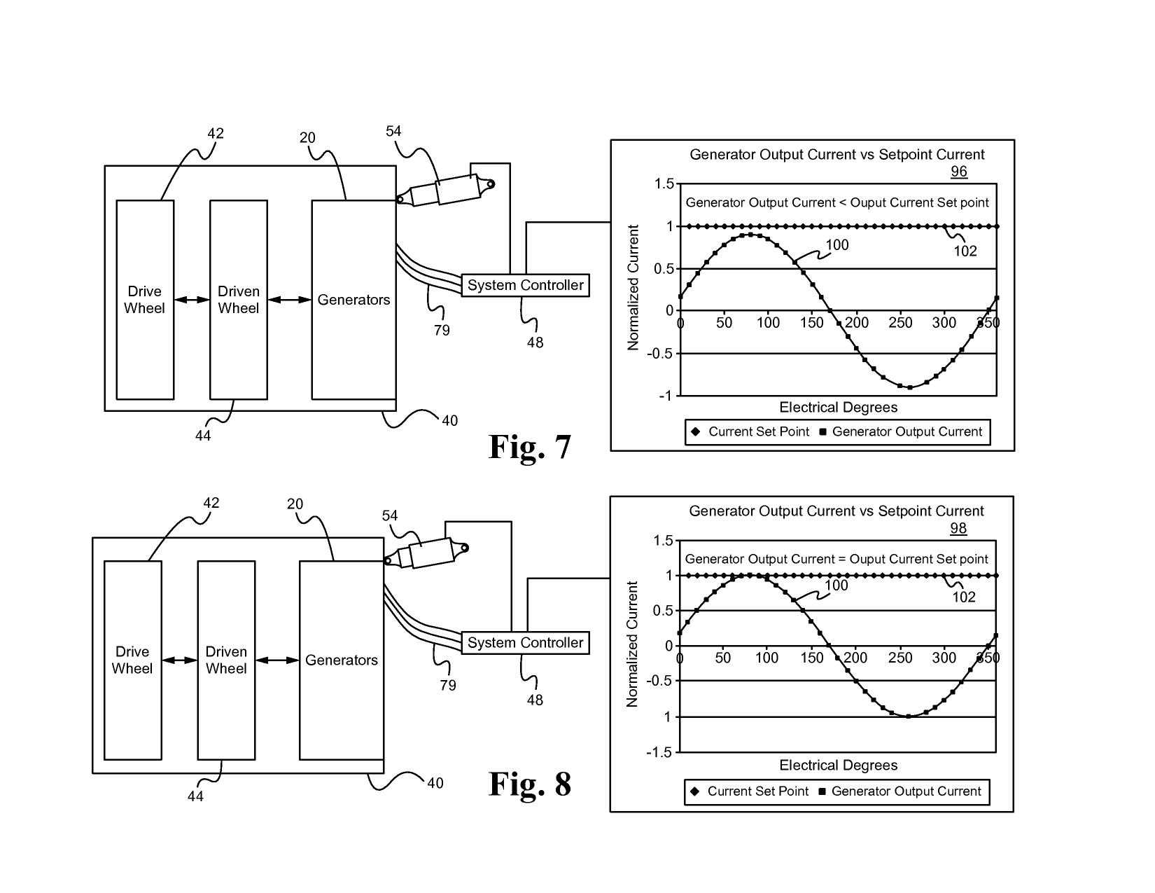

Referring now to FIGS. 3-10, various modes of operation of the system controller 48 are shown, in accordance with at least some embodiments of the present disclosure. Particularly and as explained further, the system controller 48 may operate under two modes of operation, namely, a first mode to synchronize an output frequency of the generators 20 with a frequency of the grid 60 and a second mode to control an output current flowing from the generators to the grid. Thus, FIGS. 3-6 describe the first mode of operation (e.g., synchronizing the generators 20 to the grid 60) of the system controller 48, while FIGS. 7-10 describe the second mode of operation (e.g., controlling current flow between the generators and the grid) of the system controller.

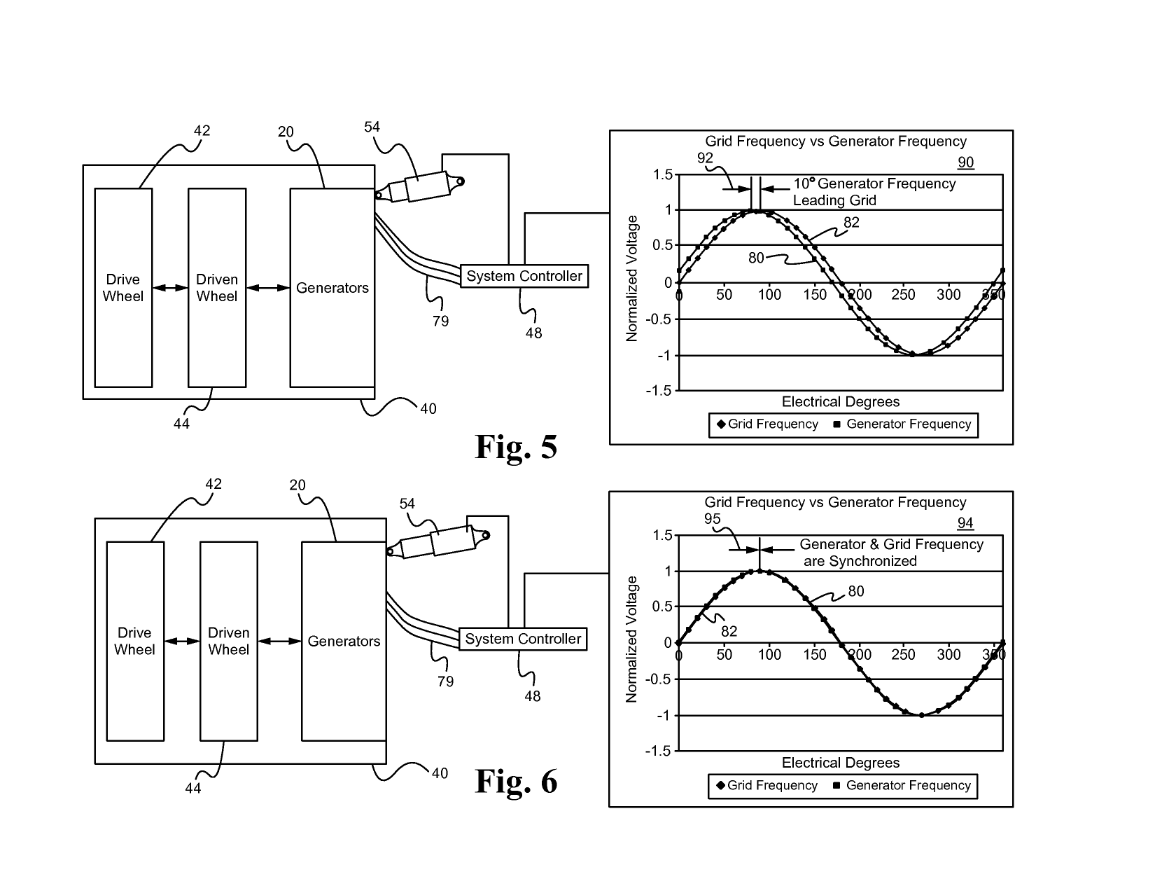

Turning specifically now to FIGS. 3-6, FIGS. 3 and 4 describe operation of the system controller 48 when the output frequency of the generators 20 lags the frequency of the grid 60, while FIGS. 5 and 6 describe operation of the system controller when the output frequency of the generators leads the frequency of the grid. As the wind turbine 2 (e.g., the rotor 8 of the wind turbine) starts to rotate, the system controller 48 may utilize the electrical sensors 62 and 64 to determine the electrical output frequency of the generators 20 and the grid 60, respectively. If the output frequency of the generators 20 is determined (as represented by graph 78, described below) to be less than the required frequency of the grid 60 (e.g., less than about 60 Hertz), then as shown in FIG. 3, the system controller 48 may signal the actuation system 50 and particularly, the linear actuator 54 to increase the speed ratio of the variable speed ratio friction wheel drive train 40, as represented by a links 79.

As described above, the speed ratio of the variable speed ratio friction wheel drive train 40 may be increased by translating the driven wheel(s) 44 relative to the drive wheel(s) 42 until the desired speed ratio increase is obtained to account for the lag in the output frequency of the generators 20. Translation of the drive wheel(2) 42 with respect to the driven wheel(s) 44 may be facilitated by the linear actuator 54, which may be extended or retracted to/from the driven wheel(s) 44 and/or the generators 20 to increase/decrease the speed ratio. Whether the linear actuator 54 is extended or retracted again depends upon the configuration of the variable speed ratio friction wheel drive train 40.

It will be understood that although only a single one of the linear actuator 54 has been shown, in other embodiments, one of the linear actuator for each one of the generators 20 may be employed to control the output frequency of the generator connected thereto. It will also be understood that it is always not necessary that the output frequencies of all of the generators 20 either lead or lag the frequency of the grid 60. Rather, in some embodiments, some of the generators 20 may lead the grid 60, while some of the generators 20 may lag the grid in which case, the speed ratio may be increased for the generators lagging the grid, while the speed ratio may be decreased for the generators leading the grid.

With respect to the graph 78, it represents exemplary plots 80 and 82, respectively, of the output frequency of the generators 20 and the frequency of the grid 60, to determine whether the generators lead or lag the grid. The graph 78, which plots a normalized voltage on the Y-Axis against one electrical cycle on the X-Axis, shows an exemplary ten degree (10°) lag 84 between the generator and the grid frequencies. Upon detecting the frequency lag, the system controller 48 may instruct the linear actuator 54 to increase the speed ratio of the variable speed ratio friction wheel drive train 40, as discussed above. As the speed ratio rises, the output rotational speed of the generators 20 and, therefore, the output frequency of the generators increases. The system controller 48 may continue to command a faster generator operating speed (e.g., continue increasing the speed ratio) until the output frequency of the generators 20 is synchronized to the frequency of the grid 60, as shown by graph 86 in FIG. 4. The graph 86 shows that the plots 80 and 82 substantially overlap with one another to indicate a substantially zero lag 88 between the generators 20 and the grid 60, thereby representing synchronization between the generators and the grid. After the generators 20 have been synchronized to the grid 60, the electrical contactors 70 may be closed to facilitate power flow from the generators to the grid.

It will be understood that the graphs 78 and 86 represent the output frequency plots of one of the generators 20 that is shown to be controlled by the linear actuator 54. Similar plots for each of the generators 20 may be plotted to determine a lag or lead of the output frequency of the generators 20 relative to frequency of the grid 60.

Referring now to FIGS. 5 and 6, operation of the system controller 48 when the output frequency of the generators 20 leads the frequency of the grid 60 is shown, in accordance with at least some embodiments of the present disclosure. Specifically, as shown in FIG. 5, if the system controller 48 senses (based upon the information received from the sensors 62 and 64) that the generators 20 are operating with an output frequency that is higher than the frequency (of for example, sixty hertz) of the grid 60, then the system controller may command the linear actuator 54 to decrease the speed ratio of the variable speed ratio friction wheel drive train 40 (and therefore, the output rotational speed of the generators), thereby reducing the output frequency of the generators until the frequency thereof is synchronized with the grid, as shown in FIG. 6.

Graph 90 of FIG. 5 may be employed for determining whether the output frequency of the generators 20 leads the frequency of the grid 60, which shows a ten degree (10°) lead 92 between the plot 80 of the generators and the plot 82 of the grid, while graph 94 of FIG. 6 may be employed for determining when the output frequency of the generators is synchronized with the frequency of the grid. Specifically, as shown in the graph 94, the plots 80 and 82 substantially overlap with one another indicating a substantially zero lead 95 or synchronization of frequencies of the generators and the grid. Once the output frequency of the generators is synchronized to the frequency of the grid 60, the system controller 48 may command the electrical contactors 70 to close, thereby electrically connecting the generator to the grid. After the generators 20 are connected to the grid 60, the system controller 48 may enter its second mode of operation, described below in FIGS. 7-10.

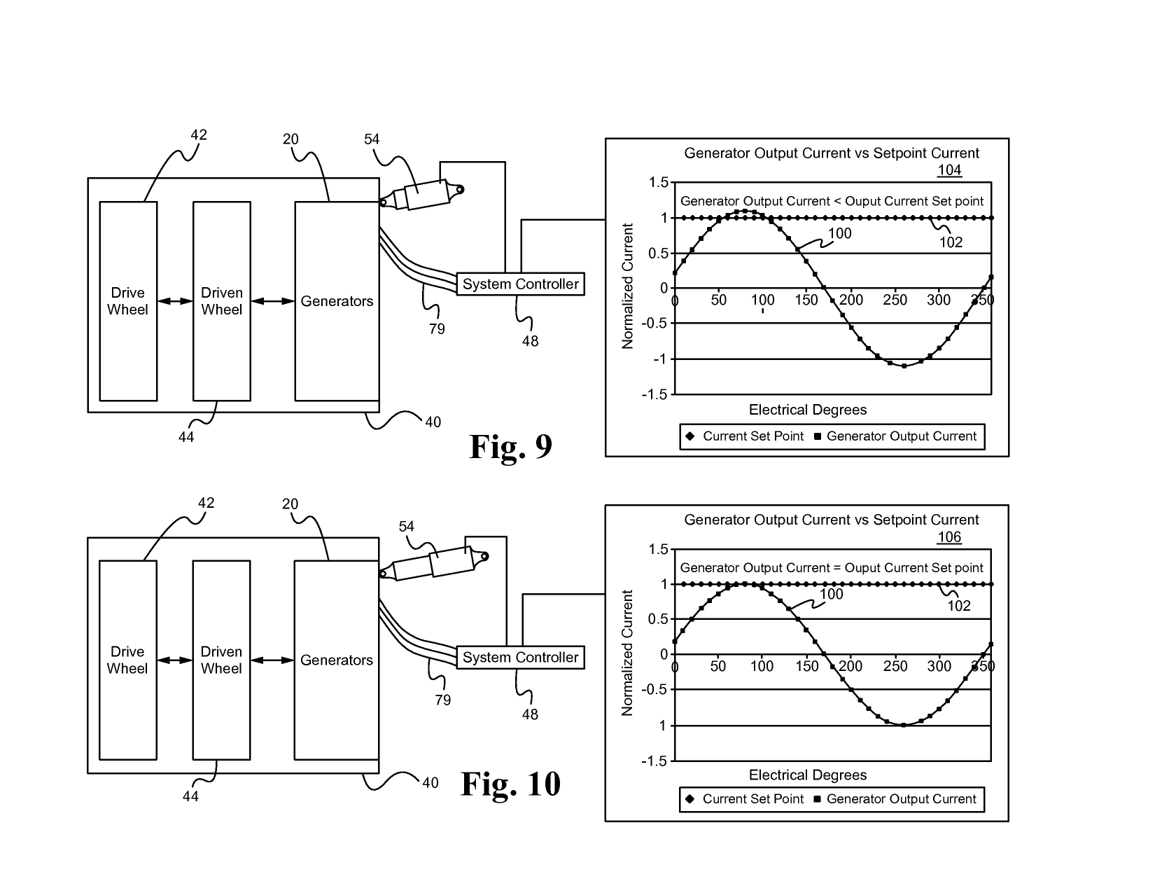

Referring now to FIGS. 7-10, the second mode of operation of the system controller 48, namely, current flow between the generators 20 and the grid 60, is described, in accordance with at least some embodiments of the present disclosure. Specifically, FIGS. 7 and 8 describe operation of the system controller 48 when an output current flowing from the generators 20 to the grid is below a particular current set point (or desired current level), while FIGS. 9 and 10 describe operation of the system controller when the output current of the generator is above the current set point.

The current control mode of operation of the system controller 48 starts after the generators 20 have been synchronized and connected to the grid 60. In the current control mode of operation, the system controller 48 utilizes the electrical sensors 62 and 64 to measure the rate at which electrical current is flowing from the generators 20 to the grid 60. If the electrical current flowing to the grid 60 from the generators 20 is less than the required current set point, as shown by graph 96 of FIG. 7, then the system controller may command the linear actuator 54 to increase the speed ratio of the variable speed ratio friction wheel drive train 40 in order to increase the output rotational speed of the generators 20. Since the generator is synchronized and connected to the grid, upon increasing the output rotational speed of the generators 20, the generators may push additional electrical current onto the grid 60 until the current set point is reached, as shown by the graph 98 of FIG. 8.

The graphs 96 and 98 of FIGS. 7 and 8, respectively, plot normalized current on the Y-Axis against electrical degrees on the X-Axis. In FIG. 7, plot 100 of the generators 20 shows a peak output current of 0.98, while the desired peak output current is 1.0. After increasing the speed ratio of the variable speed ratio friction wheel drive train 40 to increase the output rotational speed of the generators 20, as discussed above, the plot 100 may reach the set point of the plot 102 (e.g., the plot 100 may touch the plot 102) illustrating that the generator output peak current has reached the desired generator output current of 1.0.

On the other hand, if the electrical sensors 62 and 64 determine that the current flow to the grid 60 from the generators 20 is greater than the current set point, then as shown by graph 104 in FIG. 9, the system controller 48 may command the linear actuator 54 to decrease the speed ratio of the variable speed ratio friction wheel drive train in an effort to reduce the output rotational speed of the generators 20 until the current flow from the generators to the grid matches the current set point. Since the generators 20 are synchronized and connected to the grid 60, upon reducing the output rotational speed of the generators 20, the generators may push less electrical current onto the grid 60, as shown by graph 106 in FIG. 10, until the current flow is reduced to the current set point.

Notwithstanding the two modes of operation of the system controller 48 described above, it will be understood that the system controller may also support several other system level functions. For example, if the system controller 48 senses a generator fault, the linear actuator 54 may be commanded to entirely disconnect the generators 20 from the drive wheel(s) 42. If more than one generators 20 are connected to drive train 18, then the wind turbine 2 may continue to provide power at a reduced level until the faulted generator is replaced.

Thus, the present disclosure sets forth a control system for controlling operation of a variable speed ratio friction wheel speed increaser drive train that employs at least one drive wheel and at least one driven wheel to provide a constant output rotational speed of the generators connected thereto independent of the input rotational speed of the rotor of the wind turbine. Motion from the at least one drive wheel is transmitted to the at least one driven wheel through frictional forces. Furthermore, the at least one driven wheels may be translated along a surface of the at least one drive wheels in order to vary the speed ratio. By providing a variable speed ratio drive train, such as the one described above, use of a synchronous generator design within a wind turbine may be facilitated. This variable speed ratio speed increaser may produce a constant output rotational velocity, independent of the wind turbine shaft rotational velocity to regulate the output frequency and power of the generators connected to the at least one driven wheels. The variable speed ratio speed increaser friction wheel drive train may, thus, allow a wind turbine manufacturer to eliminate the expensive power electronics that are required with variable speed generators that are driven by a constant ratio speed increaser drive trains.

Furthermore, operation of the variable speed ratio friction wheel drive train to reduce or increase the speed ratio may be controlled by a system controller. The system controller may receive information, such as, rate of current flow and output frequency of the generators and the grid, from a plurality of electrical sensors and the system controller may utilize that information to reduce or increase the speed ratio of the variable speed ratio friction wheel drive train for reducing or increasing, respectively, the output rotational speed of the generators. The system controller may operate in two modes, namely, a first mode of synchronizing an output frequency of the generators with a frequency of the grid and a second mode of controlling current flow between the generators and the grid. Several other modes of operation of the system controller are contemplated and considered within the scope of the present disclosure.

While only certain embodiments have been set forth, alternatives and modifications will be apparent from the above description to those skilled in the art. These and other alternatives are considered equivalents and within the spirit and scope of this disclosure and the appended claims.

We claim:

1. A control system for controlling operation of a drive train for a wind turbine, the control system comprising:
a system controller capable of regulating an output rotational speed of one or more generators driven by a drive train of a wind turbine;
at least one electrical sensor for measuring at least an output frequency of the one or more generators, a frequency of a grid and a rate of current flow between the one or more generators and the grid, the at least one electrical sensor in at least indirect communication with the system controller for providing measurements thereto;
at least one electrical contactor for establishing a connection between the one or more generators and the grid, the at least one electrical contactor in at least indirect communication with the system controller and operating under command from the system controller; and
an actuation system in at least indirect contact with the system controller and operating under command thereof to regulate the output rotational speed of the one or more generators.

2. The control system of claim 1, wherein the drive train is a variable speed ratio friction wheel drive train having (a) at least one drive wheel adapted to receive mechanical energy from a main shaft of the wind turbine and capable of rotating at a variable input rotational speed; and (b) at least one driven wheel in at least indirect contact with the at least one drive wheel, the at least one driven wheel capable of at least indirectly translating against the at least one drive wheel to vary a speed ratio of the drive train to provide a constant output rotational speed of the one or more generators.

3. The control system of claim 2, wherein the one or more generators are connected at least indirectly to the at least one driven wheel.

4. The control system of claim 1, wherein the system controller operates in a first mode of operation comprising synchronizing the output frequency of the one or more generators with the frequency of the grid.

5. The control system of claim 4, wherein if the output frequency of the one or more generators is less than the frequency of the grid, the system controller commands the actuation system to increase the output rotational speed of the one or more generators by increasing a speed ratio of the drive train.

6. The control system of claim 4, wherein if the output frequency of the one or more generators is more than the frequency of the grid, the system controller commands the actuation system to decrease the output rotational speed of the one or more generators by decreasing a speed ratio of the drive train.

7. The control system of claim 1, wherein the system controller operates in a second mode of operation comprising regulating electric current flowing from the one or more generators to the grid.

8. The control system of claim 7, wherein the second mode of operation is activated when the output frequency of the one or more generators is synchronized with the frequency of the grid.

9. The control system of claim 7, wherein if the electric current flowing from the one or more generators to the grid is below a current set point, the system controller commands the actuation system to increase the output rotational speed of the one or more generators by increasing a speed ratio of the drive train.

10. The control system of claim 7, wherein if the electric current flowing from the one or more generators to the grid is above a current set point, the system controller commands the actuation system to decrease the output rotational speed of the one or more generators by decreasing a speed ratio of the drive train.

11. The control system of claim 1, wherein the at least one electrical contactor is closed upon synchronizing the output frequency of the one or more generators with the frequency of the grid.

12. The control system of claim 1, wherein the actuation system comprises at least one linear actuator in at least indirect contact with the one or more generators.

13. The control system of claim 1, wherein the output rotational speed of the one or more generators is increased by increasing a speed ratio of the drive train and the output rotational speed of the one or more generators is decreased by decreasing the speed ratio of the drive train.

14. A wind turbine, comprising:
a hub;
a plurality of blades radially extending from the hub;
a main shaft rotating with the hub;
a friction wheel drive train comprising (a) at least one drive wheel mounted to the main shaft and rotating at a variable input rotational speed; and (b) at least one driven wheel in at least indirect contact with the at least one drive wheel, the at least one driven wheel capable of providing a constant output rotational speed of one or more generators connected to the at least one driven wheel by varying a speed ratio of the friction wheel drive train; and
a control system capable of controlling the output rotational speed of the one or more generators to at least (a) synchronize an output frequency of the one or more generators with a frequency of a grid; and (b) after synchronizing, controlling current flow from the one or more generators to the grid.

15. The wind turbine of claim 14, further comprising an actuation system for controlling the output rotational speed of the one or more generators upon command from the system controller.

16. The wind turbine of claim 14, wherein the speed ratio of the drive train is varied by translating the at least one driven wheel at least indirectly against a surface of the at least one drive wheel to change a contact location therebetween, the change in contact location varying the speed ratio of the drive train.

17. The wind turbine of claim 14, wherein the drive train is a variable speed ratio speed increaser friction wheel drive train.

18. A method of controlling operation of a friction wheel drive train for a wind turbine, the method comprising:
providing a control system having (a) a system controller capable of regulating an output rotational speed of one or more generators driven by a drive train of a wind turbine; (b) at least one electrical sensor for measuring at least an output frequency of the one or more generators, a frequency of a grid and a rate of current flow between the one or more generators and the grid, the at least one electrical sensor in at least indirect communication with the system controller for providing measurements thereto; (c) at least one electrical contactor for establishing a connection between the one or more generators and the grid, the at least one electrical contactor in at least indirect communication with the system controller and operating under command from the system controller; and (d) an actuation system in at least indirect contact with the system controller and operating under command thereof to regulate the output rotational speed of the one or more generators;
receiving measurements by the system controller from the at least one electrical sensor;
synchronizing the output frequency of the one or more generators with the frequency of the grid by utilizing the actuation system based upon the measurements received from the at least one electrical sensor;
connecting the one or more generators to the grid after synchronizing by closing the at least one electrical contactor; and
controlling electric current flowing from the one or more generators to the grid after synchronizing and connecting the one or more generators to the grid by utilizing the actuation system based upon the measurements received from the at least one electrical sensor.

19. The method of claim 18, wherein synchronizing the output frequency of the one or more generators with the frequency of the grid comprises:
increasing the output rotational speed of the one or more generators if the output frequency of the one or more generators is less than the frequency of the grid; and
decreasing the output rotational speed of the one or more generators if the output frequency of the one or more generators is more than the frequency of the grid.

20. The method of claim 18, wherein controlling electric current flowing from the one or more generators to the grid comprises:
increasing the output rotational speed of the one or more generators if the electric current flowing from the one or more generators to the grid is less than a current set point of the grid; and
decreasing the output rotational speed of the one or more generators if the electric current flowing from the one or more generators to the grid is more than a current set point of the grid.
